(19) United States
(12) Patent Application Publication
(10) Pub. No.: US 2005/0237569 A1
(43) Pub. Date: Oct. 27, 2005

(54) Communication apparatus, a communication management program, a communication information managing method, and a storage medium

(76) Inventor: Kazuya Takahashi, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/111,848

(22) Filed: Apr. 22, 2005

(30) Foreign Application Priority Data
Apr. 26, 2004 (JP) 2004-129424

(51) Int. Cl. G06F 15/00

(52) U.S. Cl. 358/1.15

(57) ABSTRACT

A communication apparatus, a communication management program, and a storage medium are disclosed. The communication apparatus includes a visual output unit such as a printer and a display screen that outputs various visible information items, a setting unit that sets up one or more items of communication information concerning the communication history that are not to be visually output, and an output unit that outputs the communication information concerning the communication history to the output unit according to the setup carried out by the setting unit such that selected items are not visually output.

### BACKGROUND OF THE INVENTION

1. Field of the Invention

The present invention generally relates to a communication apparatus such as a facsimile apparatus, a communication management program, and a storage medium.

2. Description of the Related Art

Generally, a communication apparatus such as a facsimile apparatus (including MFP) has a function to output communicative history, e.g., by printing on recording paper or by displaying on a screen such that the communication history is provided to a user (for example, Patent Reference 1 discloses a communication result report outputting function).

[Patent Reference 1] JPA, 2001-45305

[Problem(s) to be Solved by the Invention]

According to conventional practices, the communication history such as a transmission result report and a non-delivery report is automatically output by printing and/or displaying after a while after a transmitting operation is preformed. That is, there is a chance of a third person other than the user concerned easily viewing the communication history that includes an address of the receiving party.

With the increasing trend for information security and privacy, it is often required that information as to “who sends to whom” be protected. This is especially the case in a facsimile transmission, wherein the user usually leaves the facsimile apparatus as soon as a manuscript is read and transmission thereof starts, and address information is displayed during the transmission and is printed after the transmission. That is, there is a chance of a third party viewing the communication history including address information.

Accordingly, an object of the present invention is to enhance the security of the communication information concerning the communication history.

### SUMMARY OF THE INVENTION

It is a general object of the present invention to provide a communication apparatus such as a facsimile apparatus, a communication management program, a communication information managing method, and a storage medium that substantially obviate one or more of the problems caused by the limitations and disadvantages of the related art.

Features and advantages of the present invention are set forth in the description that follows, and in part will become apparent from the description and the accompanying drawings, or may be learned by practice of the invention according to the teachings provided in the description. Objects as well as other features and advantages of the present invention will be realized and attained by a communication apparatus such as a facsimile apparatus, a communication management program, a communication information managing method, and a storage medium particularly pointed out in the specification in such full, clear, concise, and exact terms as to enable a person having ordinary skill in the art to practice the invention.

To achieve these and other advantages and in accordance with the purpose of the invention, as embodied and broadly described herein, the invention provides a communication apparatus such as a facsimile apparatus, a communication information managing method, a communication management program, and a storage medium as follows.

[Means for Solving the Problem]

In order to protect communication information concerning communication history from third party viewing, the communication apparatus of the present invention includes: setting means for setting up one or more items of the communication information concerning communication history to be displayed/printed, or not to be displayed/printed; output means for outputting the communication information according to the set up carried out by the set up unit; and visual outputting means such as a printer and a display for visually outputting the communication information provided by the output unit. The communication information concerning the communication history includes a recipient's address/name/telephone number in communications such as facsimile communications.

The communication information managing method of the present invention includes: a step of setting up (selecting) one or more items of the communication information concerning the communication history to be displayed/printed, or not to be displayed/printed; a step of outputting the communication information according to the setup carried out by the step of setting up; and a step visually outputting the communication information provided by the step of outputting.

The present invention further includes the communication management program that is for a computer to execute the communication information managing method, and the storage medium that stores the communication management program.

[Effect of the Invention]

According to the present invention, information that should not be divulged is made invisible to a third party; but rather, all the information is available to an authorized communication manager, and a general authenticated user can obtain the information about communications of his/her own.

In this manner, the objective of the present invention, i.e., enhancement of the security of the communication information concerning the communication history is achieved.

### BRIEF DESCRIPTION OF THE DRAWINGS

FIG. 1 is a block diagram showing an outline hardware structure of a facsimile apparatus according to an embodiment of the present invention;

FIG. 2 is a plan view showing an example structure of a control-panel unit;

FIG. 3 is a flowchart showing an outline of an example of a setting process;

FIG. 4 is a plan view showing an example screen display of a display screen of the setting process;

FIG. 5 is a table showing an example of parameter setting;

FIG. 6 is a list showing an example of a printed parameter setting list;

FIG. 7 is a flowchart showing an example of an output process;

FIG. 8A shows an example of a display of communication information during communication according to the embodiment of the present invention;

FIG. 8B shows an example of a display of communication information during communication according to conventional practice;

FIG. 9A shows an example of a transmission result report according to the embodiment of the present invention;

FIG. 9B shows an example of a transmission result report according to conventional practice;

FIG. 10A shows an example of a non-delivery report according to the embodiment of the present invention;

FIG. 10B shows an example of a non-delivery report according to conventional practice;

FIG. 11 is a flowchart showing an example of a communication management report output process;

FIG. 12 shows an example of a communication management report provided to a communication manager;

FIG. 13 shows an example of a communication management report provided to a general user; and

FIG. 14 shows an example of a communication management report provided to an unauthorized user.

### DESCRIPTION OF THE PREFERRED EMBODIMENTS

In the following, embodiments of the present invention are described with reference to the accompanying drawings. A communication apparatus according to the embodiment of the present invention is described as being applied to a facsimile apparatus having an MFP structure, for example.

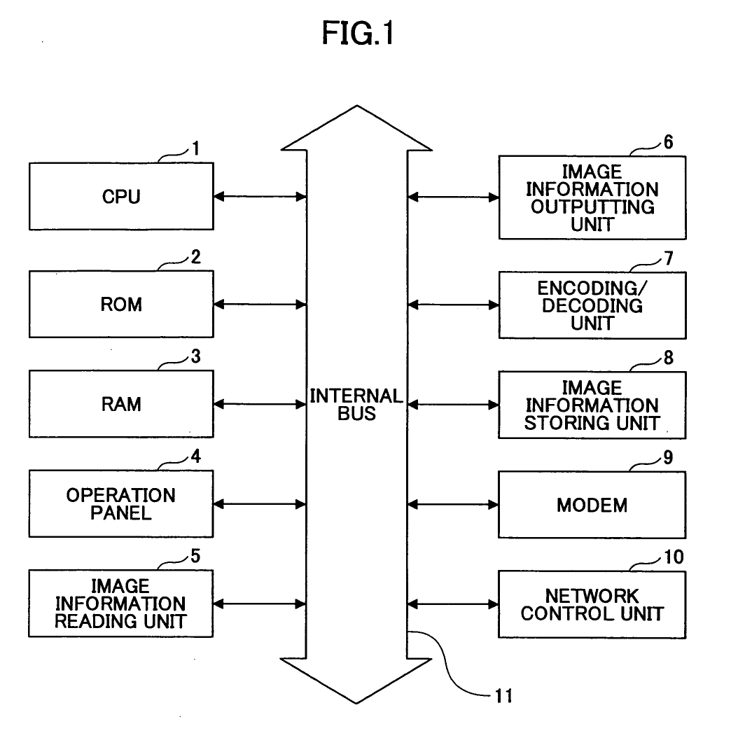

FIG. 1 is a block diagram showing the outline of the hardware structure of the facsimile apparatus according to the embodiment. The facsimile apparatus, which is compliant with G3/G4, according to the embodiment includes a microcomputer that is constituted by CPU 1, ROM 2 and RAM 3 so that it carries out various control processes. The processes include a control process of various units of the facsimile apparatus, and a facsimile transmission control process. The ROM 2 stores a control program and a process program that the CPU 1 executes. That is, according to the embodiment, the ROM 2 stores the program for realizing various communication management functions that are described below. That is, the ROM2 serves as a storage medium for storing the program. For this purpose, according to the embodiment, the ROM 2 is constituted by, e.g., an EEPROM and a flash memory such that the program stored in the ROM 2 may be rewritten. In addition, if the program is to be downloaded via a network, a network interface, which is not illustrated, is added. The RAM 3 functions as a working space.

The facsimile apparatus further includes: a control-panel unit 4 that is operated by a user (operator), and displays an operational status of the facsimile apparatus, details of which are described below; an image information reading unit 5 that serves as a scanning unit so that it reads an image of a manuscript to be transmitted; and an image information outputting unit 6, which is served by a printer, for recording various information items including image information on recording paper. For example, the printer is a laser beam printer using an electrophotography method. According to the embodiment, the image information outputting unit 6 serves as a visual output unit by outputting visible image information on the recording paper.

The facsimile apparatus further includes: an encoding/decoding unit 7 that carries out data compression (encoding compression) of the image information to transmit, and restores received image information into original image information (decoding); an image information storing unit 8 that stores image information that is encoded and compressed; and a modem 9 that is capable of providing a slow-modem function for exchanging transmission control procedures, and a fast modem function for mainly exchanging image information so that it realizes the G3/G4 modem functions.

The facsimile apparatus further includes a network control unit 10 for connecting the facsimile apparatus to a public switched telephone network (PSTN) so that it is capable of performing automated transmission and reception functions.

The above-described components are connected to an internal bus 11 such that data are exchanged between the components mainly through the internal bus 11. Nevertheless, an exchange of the data between the network control unit 10 and the modem 9 is directly (not through the internal bus 11) performed.

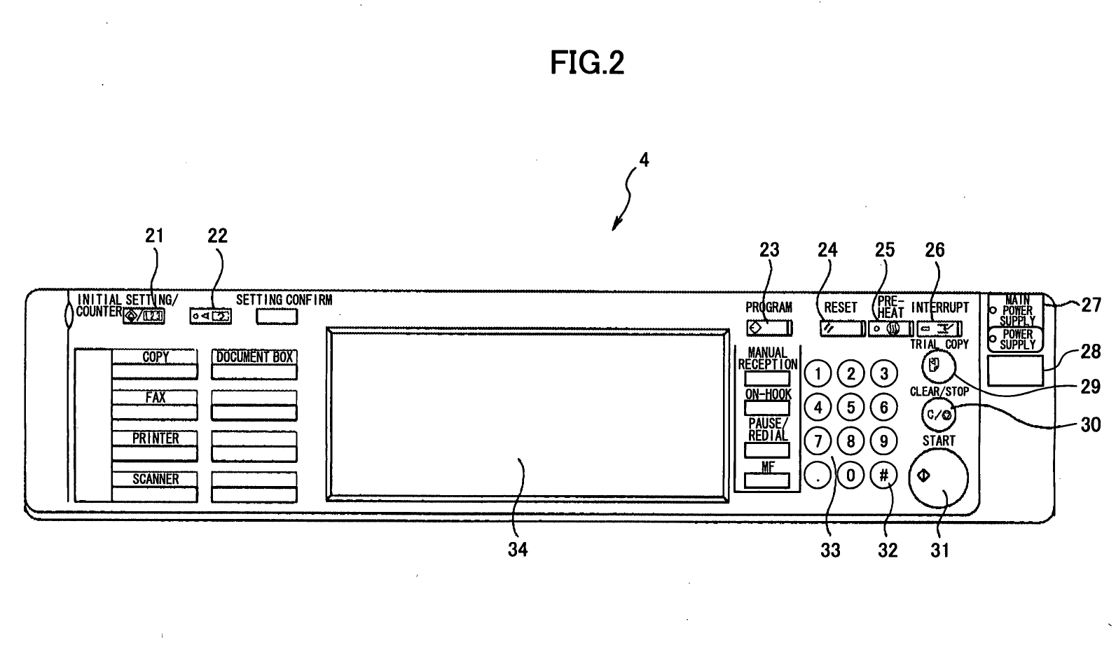

An example of the control-panel unit 4 according to the embodiment is shown in FIG. 2. As shown in the upper left-hand side part of FIG. 2, the control-panel unit 4 includes an initial setting/counter key 21, a color adjustment/registration key 22, and so on, which are used by a communication manager when setting up an initial condition, parameter items, and the like.

As shown in the upper right-hand side part of FIG. 2, the control-panel unit 4 includes a program key 23, a reset key 24, a preheating key 25, an interruption key 26, a power supply lamp 27, a power supply key 28, etc. At the lower part, a trial copy key 29, a clear/stop key 30, a start key 31, an enter (#) key 32, ten keys 33, and the like are provided.

At the center of the control-panel unit 4, a display screen 34 is provided, which displays a message, an operations instruction, a status of the facsimile apparatus, and the like. The display screen 34 is, e.g., an LCD display with a touch panel function so that it serves as a visual output unit that outputs various visible information items.

As for transmission/reception operations, the facsimile apparatuses according to the embodiment carry out the same operations as general facsimile apparatuses; therefore, explanations are omitted. Rather, a detailed description follows about information management of communication history accompanying the transmission/reception operations. Here, it is assumed that a user name and a password (user ID) are required when using the facsimile apparatus as a part of a security function. That is, the display screen 34 shows a message that reads, e.g. “input user name and password”. When a user name and a password are input, they are verified through an individual authentication process. Further, there are two kinds of authentication provided, such as manager authentication and general user authentication. Here, the authentication may be carried out using a conventional method such as using an IC card, etc.

Further, it is assumed that the facsimile apparatus is set to a mode wherein a transmission result report is automatically printed when the communication is successful, and a non-delivery report is automatically printed when the communication fails, when a communications process is finished.

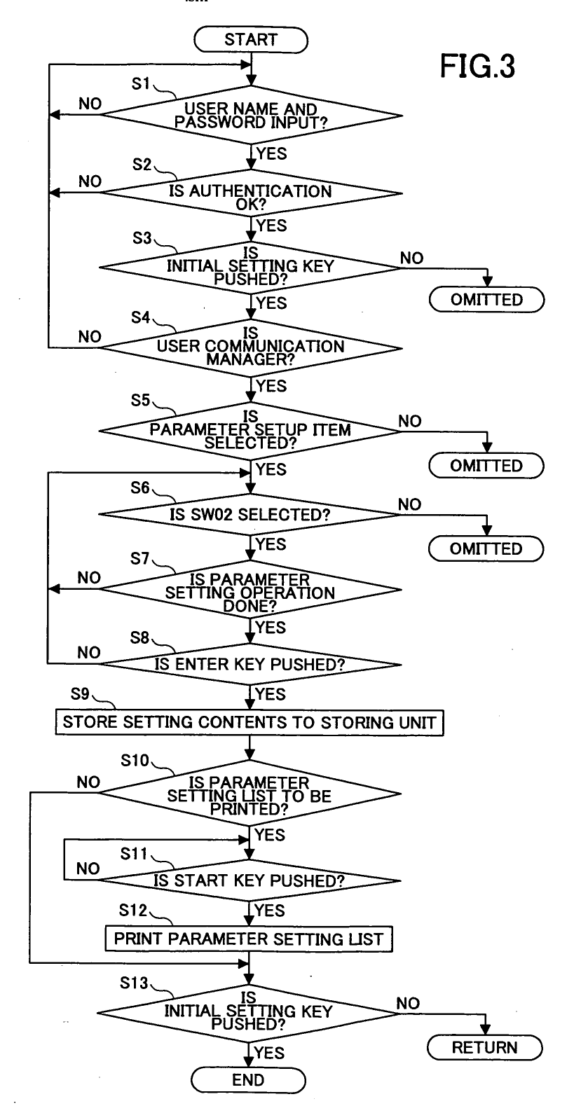

According to the embodiment, the communication manager sets up contents that are to be printed (or displayed), and contents that are not to be printed (or displayed) in the communication history such as the transmission result report and the non-delivery report. This process is described with reference to FIG. 3 through FIG. 6. FIG. 3 is a flowchart showing an example of the setting process that is performed by the CPU 1. At the initial state, the display screen 34 shows, e.g., “input user name and password”. Whether a user name and a password are input is determined at Step S1. If the determination is affirmative (Y at S1), an authentication process is performed, and whether the authentication is granted is determined at S2. If the determination is affirmative (Y at S2), login to the facsimile apparatus is admitted. Then at S3, it is determined whether the initial-setting key (initial setting/counter key 21) is pushed. A process when the initial-setting key is not pushed (N at S3) is omitted. Since only the communication manager is authorized to perform the initial-setting operation, when the initial-setting key is pushed (Y at S3), whether the current user is the communication manager is determined at S4. If the determination is negative, i.e., the current user is a general user (N at S4), the process returns to Si. If the determination is affirmative, i.e., the current user is the communication manager (Y at S4), the initial-setting operation is permitted and items of the initial-setting operation are displayed on the display screen 34. Here, if “parameter setup item” is chosen on the screen display (Y at S5), a next screen is displayed. Then, if “user switch SW02” is chosen in the next screen (Y at S6), a setting operation is enabled so that an output form of the communication information concerning the communication history is defined, which is the objective of the embodiment of the present invention.

That is, parameters are selected by setting up one of user switches SW02 through SW07. For example, the user switch SW02 is assigned to setting up the output form of the communication information concerning the communication history. Here, each of the switches SW02 through SW07 represents eight binary bits, each being either “1” or “0”. A function is set up by setting a predetermined binary bit to “0” or “1” as appropriate.

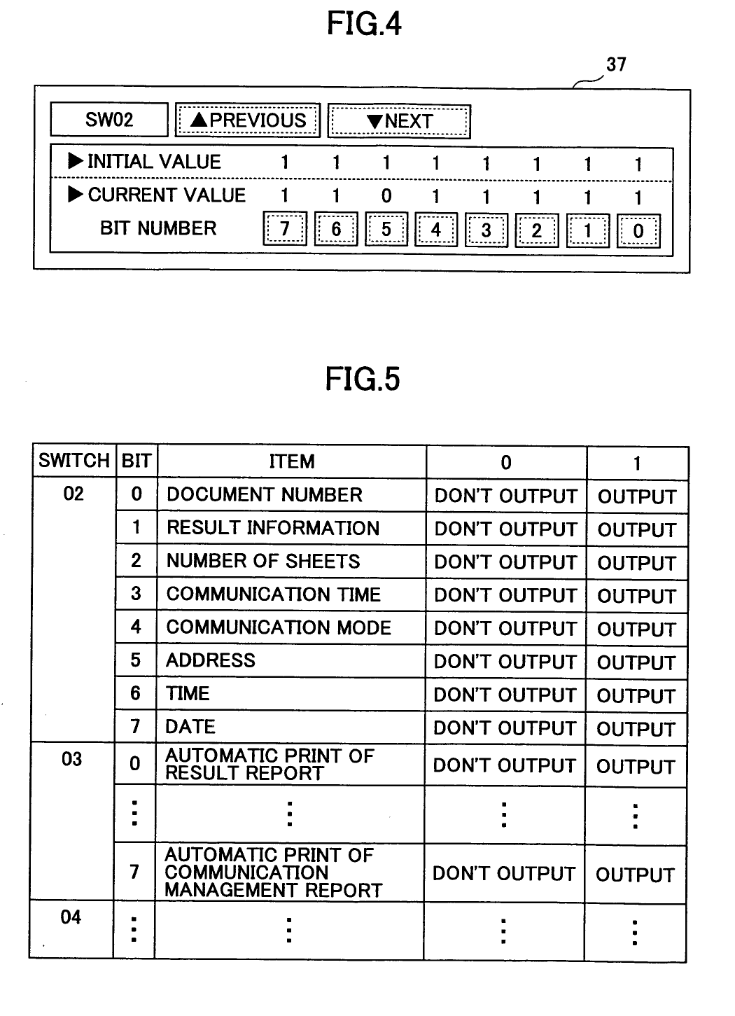

FIG. 4 shows an example of a screen display of the display screen 34 corresponding to the user switch SW02, which characterizes the embodiment. That is, as a parameter-setup screen, initial values and current values are displayed. Numbers “0” through “7” associated with “Bit Numbers” correspond to respective bit numbers. For example, if the bit number “3” is pushed, the value of the bit 3 toggles between “0” and “1”. Each of the bit numbers “0” through “7” serves as follows as shown by FIG. 5, namely,
Bit number 7: Whether date information is to be output,
Bit number 6: Whether time information is to be output,
Bit number 5: Whether address is to be output,
Bit number 4: Whether communication mode information is to be output,
Bit number 3: Whether communication time information is to be output,
Bit number 2: Whether number-of-sheets information is to be output,
Bit Number 1: Whether a communication result is to be output, and
Bit number 0: Whether document number is to be output.

As above, each item can be individually setup. According to the present embodiment, when the value of a bit is set at “0”, the corresponding item is not output, i.e., not displayed, and not printed, that is, the item is treated as information not to be visually output. In initial setting at the time of factory shipment, all the bits are set at “1” so that all the corresponding items are printed or displayed. FIG. 4 shows an example wherein the bit number 5 of the user switch SW02 is changed from “1” (printing/display output to be carried out) to “0” (printing/display output not to be carried out). Here, if a name corresponding to a telephone number (FAX number) is beforehand registered, the name serves as the address. Otherwise, the telephone number is used as the address.

When the parameter-setup operation is carried out (Y at S7) on the screen display as shown in FIG. 4, and an operation of the “enter” key (execute key) is carried out (Y at S8), the parameter setting up is completed, and the contents of the setting are loaded in the RAM 3 (S9). The contents are loaded, for example, as shown in FIG. 5, wherein each parameter item is associated with a binary value “1” or “0”. The process Steps S5 through S9 serve as setting means and a setting function. Accordingly, the user switch SW02 constitutes a setting unit.

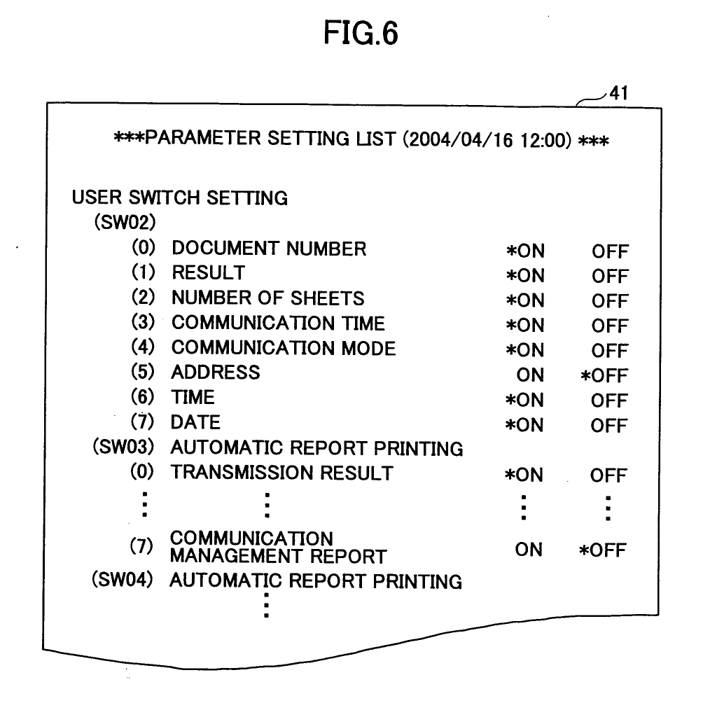

After the setting operation described above, if the initial-setting key (initial setting/counter key 21) is pushed again (S13), the series of the setting processes is ended. Nevertheless, if printing a parameter setting list is requested (Y at S10), and the start key 31 is pushed (Y at S11), the contents of the parameter setup are read from the RAM 3, and the parameter setting list is printed by the image information outputting unit 6 (S12). The process of Step S12 serves as second output means. An example of the parameter setting list 41 is shown in FIG. 6. In this list 41, “1” and “0” associated with each setting item correspond to “ON” and “OFF”, respectively. Further, an asterisk that is prefixed to “ON” and “OFF” indicates what is currently set up. In this manner, the communication manager can easily ascertain the present parameter-setup status from the parameter setting list 41, which may be printed or displayed, or both, as desired. Further, the parameter setting list 41 may show all the user switches, or any specific ones such as the switch SW02, as required.

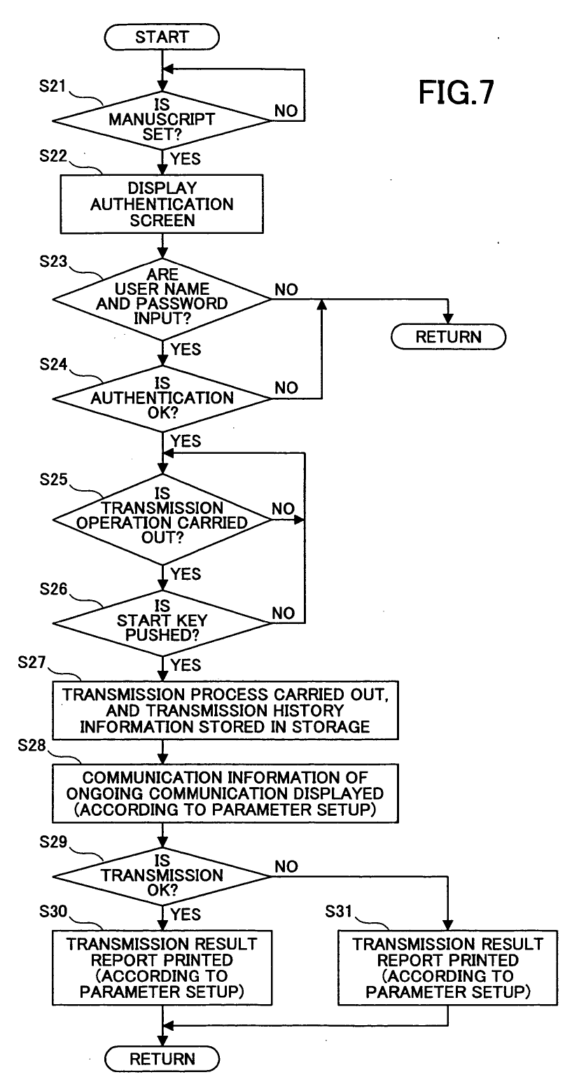

An output process of the communication information concerning the communication history when a facsimile transmission takes place under the parameter setting as described above is explained with reference to FIG. 7 through FIG. 10. FIG. 7 is an outline flowchart showing an example of the output process performed by the CPU 1.

First, a facsimile transmitting operation starts with placing a manuscript on an ADF, and the like, of the image information reading unit 5. When the manuscript is placed (Y at S21), the initial screen of the display screen 34 reads, e.g., “input user name and password” (S22), and inputting of the user ID information (a user name and a password) is prompted. Then, it is determined whether the user ID information is input (S23). If the determination is affirmative (Y at S23), the authentication process is performed. When the authentication is successful (Y at S24), the process proceeds to the transmitting process. Then, it is determined whether the user carries out a transmitting operation such as inputting a telephone number of the addressee by using the ten key 33, and the like (any method of telephone number inputting is acceptable such as hitting a one-touch key). If the determination is affirmative (Y at S25), and the start key 31 is pushed (Y at S26), transmission starts according to a well-known facsimile communication procedure (S27). At this juncture, a part of the information about the communication history (such as date, address, and communication mode) is held in a space prepared in the RAM 3 for holding the communication history items one by one, and at the same time, the communication information of the current communication is displayed on the display screen 34 as the communication information concerning the communication history is acquired (S28). Under the present circumstances, the communication information concerning the communication history is output to the display screen 34 according to the parameter setup of the user switch SW02. According to the example of the embodiment, since the setup is such that the address is not output as described above, the address is not displayed.

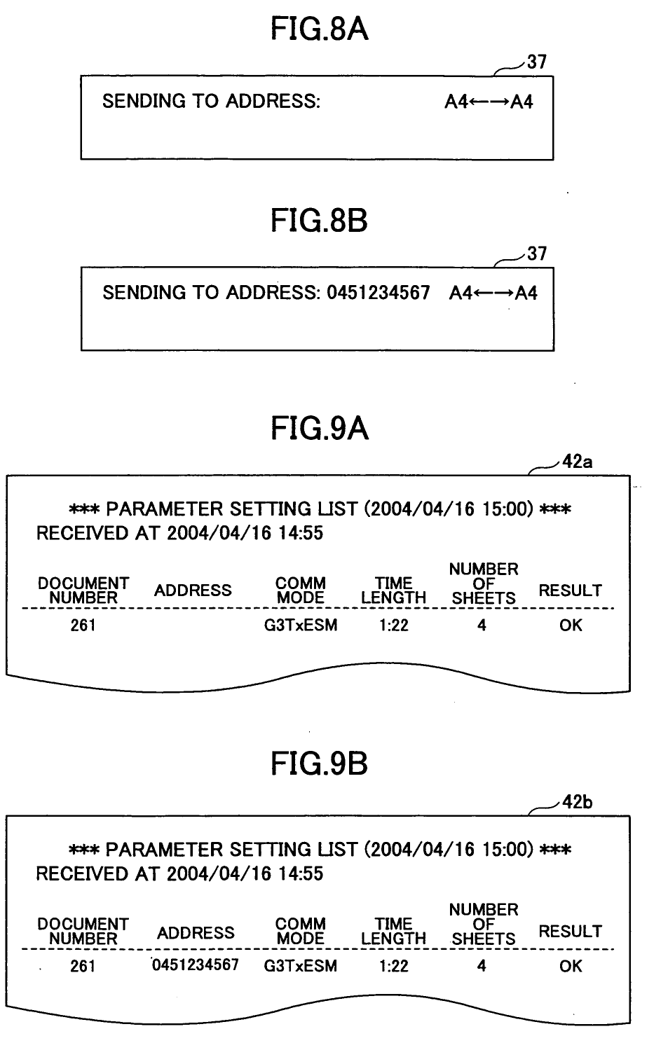

Conventionally, the address is displayed as shown by FIG. 8B. According to the present invention, the parameter can be set up by the user switch SW02 such that the address is not displayed on the display screen 34 as shown by FIG. 8A. Accordingly, even if the user leaves the facsimile apparatus, and the display screen 34 may be viewed by a third person during communication, since the address is not displayed, communication security is enhanced.

Afterward when the transmission is finished, it is determined whether the communication is successful according to a facsimile communication procedure (S29). At the same time, the information about the communication history containing the transmitting result, number of sheets, communication time, etc., is loaded in the space of the RAM 3 for holding the information about the communication history. When the communication is successful (Y at S29), a transmission result report is printed by the image information outputting unit 6 (S30). Under the present circumstances, the communication information concerning the communication history is output to the image information outputting unit 6 according to the parameter setup by the user switch SW02. That is, if showing the address is prohibited, the transmission result report does not contain the address.

Conventionally, the communication information including the address is printed in a transmission result report 42b as shown in FIG. 9B. According to the present invention, a transmission result report 42a that does not contain the address is printed as shown by FIG. 9A pursuant to the parameter setup by the user switch SW02. Therefore, even if the transmission result report 42a is viewed by a third person, communication security is attained.

In the case where the transmission fails even after retry (N at S29), a non-delivery report containing the communication information concerning the communication history is printed by the image information outputting unit 6 (S31). At this time, the communication information concerning the communication history is output to the image information outputting unit 6 according to the parameter setup by the user switch SW02. According to the example of the present embodiment, since the address is set up not to be output as described above, the address is not printed in the non-delivery report.

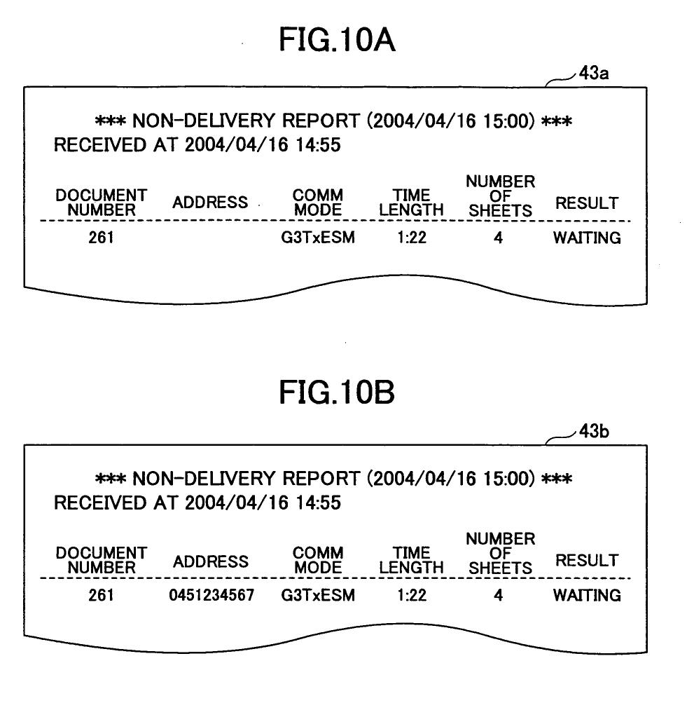

According to the conventional practice, a non-delivery report 43b contains the address as shown in FIG. 10B. However, according to the present invention, outputting of the communication information follows the parameter set up by the user switch SW02, and the address is not output to a non-delivery report 43a as shown in FIG. 10A. In this manner, even if a third person views the non-delivery report 43a, the address is not shown, and communication security is attained.

Steps S28, S30, and S31 serve as output means and an output function. Although the example described above refers to printing of the transmission result report and the non-delivery report by the image information outputting unit 6, it is evident that the transmission result report and the non-delivery report can be displayed on the display screen 34.

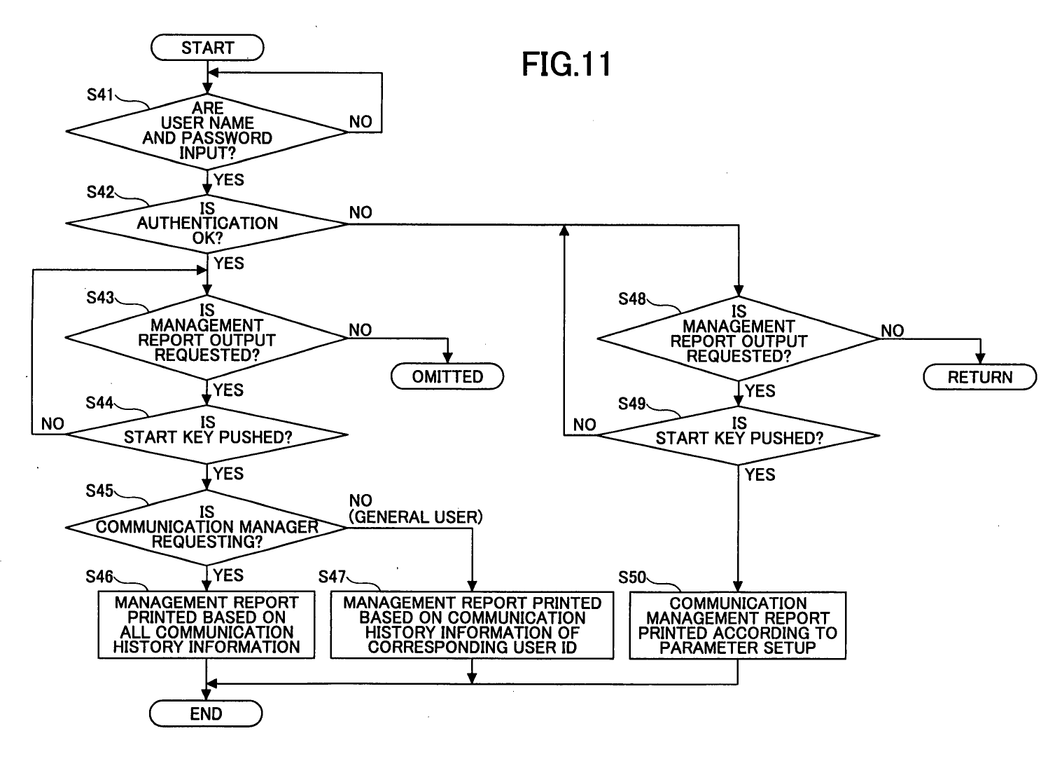

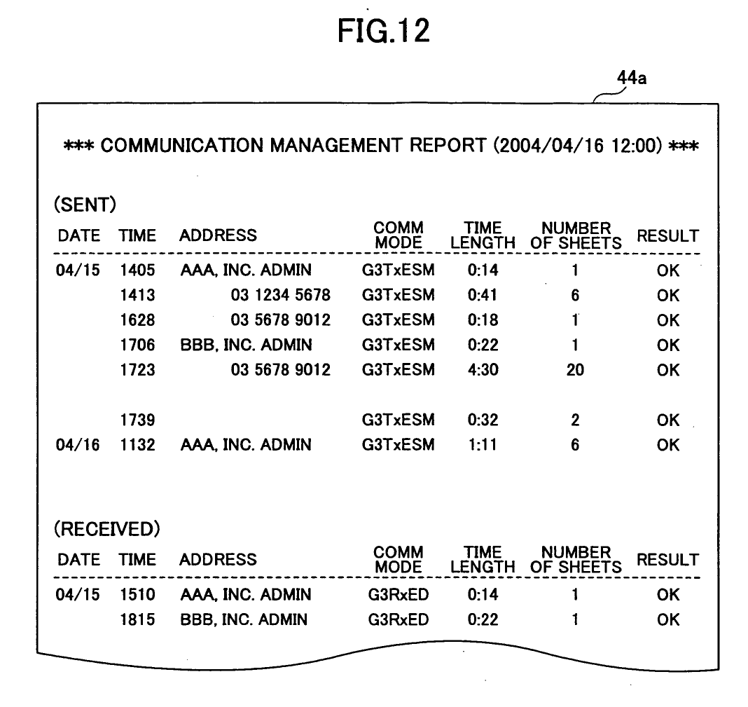

Next, a description follows with reference to FIG. 11 through FIG. 14 as to retrieving an item that is excluded from the object of printing/display, the item specifically being the address according to the example. According to the embodiment, the item hidden from printing/displaying is available in a communication management report. FIG. 11 is a flowchart showing an example of a communication management report output process performed by the CPU 1. The initial screen of the display screen 34 reads, e.g., “input user name and password”. It is determined whether user ID information (a user name and a password) is input (S41). If the determination is affirmative (Y at S41), the authentication process is performed. If the input is authenticated (Y at S42), it is then determined whether an output of a communication management report 44a is requested by operating the operation display 4 (S43). If the determination is affirmative (Y at S43), it is then determined whether the start key 31 is pushed (S44). If the determination is affirmative, it is then determined whether the user that is previously authenticated (at S42) is the communication manager (S45). If the determination is affirmative (Y at S45), the communication information on the communication history about all communications (transmission and reception) held in the RAM 3 is output to the image information outputting unit 6, which then prints out the communication management report 44a as shown in FIG. 12 (S46). That is, the communication manager is capable of obtaining all the communication information including the address, overriding the parameter set up by the user switch SW02.

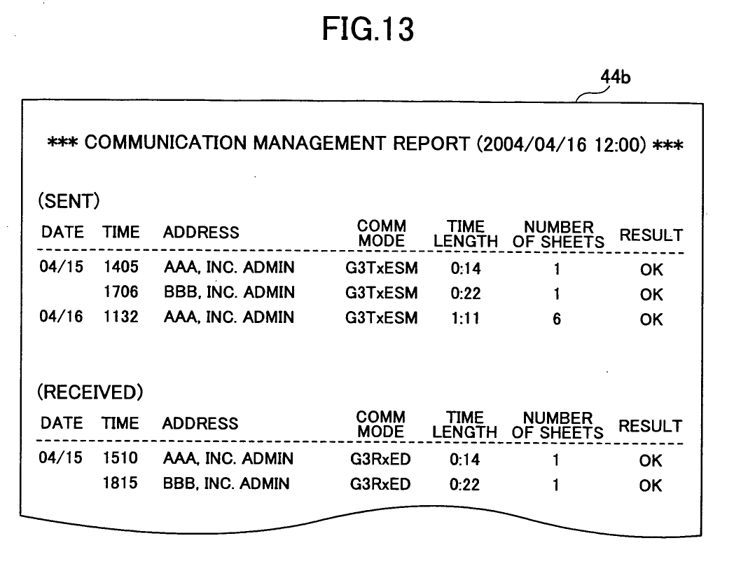

In the case that the authenticated user is not the communication manager but a general user (N at S45), only the communication history (transmission and reception) concerning the user, determined by the user ID, is output from the RAM 3 to the image information outputting unit 6. The image information outputting unit 6 prints the communication management report 44b only for the user as shown in FIG. 13 (S47). That is, the general user can obtain the communication management report 44b concerning only his/her communications, which report contains the address, overriding the parameter set up by the user switch SW02. Here, since communication history of other users is not provided, the security of the communication information, especially addresses, about other users is attained.

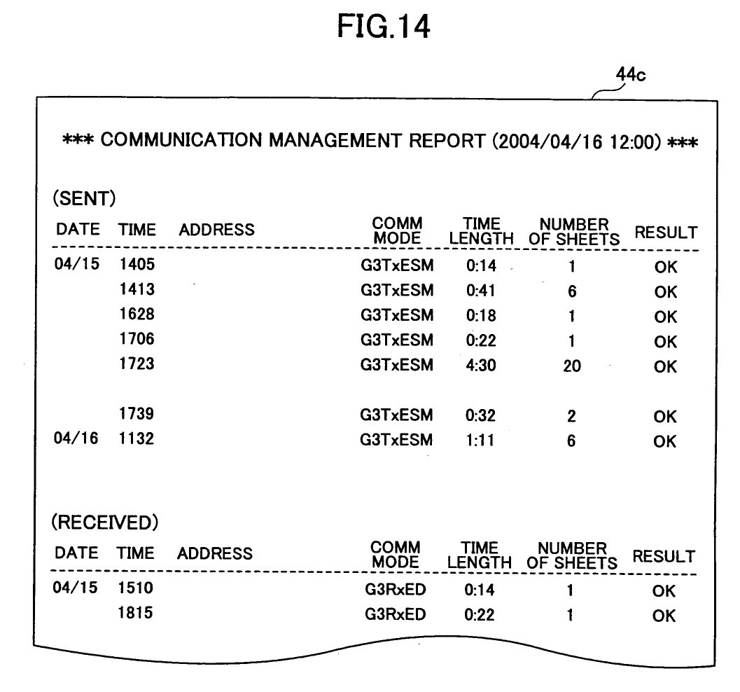

Even if the user is not authenticated (N at S42), a communication management report can be made available (S48 and S49), wherein the communication information on the communication history about all communications (transmission and reception) held in the RAM 3 is output to the image information outputting unit 6 according to the parameter set up by the user switch SW02. The image information outputting unit 6 prints a communication management report 44c, wherein the address is not printed as shown in FIG. 14 (S50). The process of Step S50 is performed as output means.

As described above, the address, for example, is protected from third person viewing, the address including a receiver's address of a transmitted message, and a sender's address of a received message. Accordingly, the security of the communication information concerning the communication history is enhanced.

Although the example is described as outputting a printout of the communication management report by the image information outputting unit 6, it is evident that the communication management report may be displayed on the display screen 34, which is included in the present invention.

Further, although the example is described as selecting an item, such as the address, not to be printed/displayed in its entirety, the present invention may be configured such that only a part of the item is concealed (for example, last 4 digits of a telephone number are not printed). Alternatively, all or a part of a telephone number may be substituted by one or more asterisks such as “****”. In other words, a variation to the selection between “print” and “not-print” of the embodiment can be a selection between “print” and “substituted print”.

Further, according to the embodiment, the parameter setting is individually provided to “date”, “time”, “address”, “communication mode”, “communication time”, “number of sheets”, “result”, and “document number”. Nevertheless, other items such as “communication charge” and “sender name” may be included, or further alternatively, a configuration may be such that only the parameter of “address” is capable of being set up.

Further, although the parameter set up by the user switch SW02 is applicable to all the users of the facsimile apparatus according to the embodiment, the facsimile apparatus may be configured such that the user switch SW02 is available to each user, for example, information is held in the RAM 3 for each user ID such that output is controlled by the user's specific setup.

Next, a modification is explained. There is a practice wherein the sender's telephone (facsimile) number is suffixed by a sender's ID number. Such sender IDs are pre-registered by the sending and receiving parties, and enable the receiver to identify a sending individual. For example, a telephone number “04551112222” is suffixed by a sender ID “1234” so that “045511122221234” is transmitted. In this case, according to the conventional practice, the sending individual can be identified by a third person viewing the communication information concerning the communication history, such as the transmission result report and the non-delivery report, which can be undesirable if in fact, a request has been made that the sender ID be not output. According to the present invention, it can be arranged such that only the telephone number may be output, excluding the sender ID, or substituting the sender ID by “****”.

Further, the present invention is not limited to these embodiments, but variations and modifications may be made without departing from the scope of the present invention.

The present application is based on Japanese Priority Application No. 2004-129424 filed on Apr. 26, 2004 with the Japanese Patent Office, the entire contents of which are hereby incorporated by reference.

1. A communication apparatus capable of transmitting and receiving information, comprising:
visual output means for visually outputting various information items;
setting means for selectively setting up information that is not to be visually output, the information being contained in communication information concerning communication history; and
output means for outputting the communication information concerning the communication history to the visual output means according to the setup carried out by the setting means.

2. The communication apparatus as claimed in claim 1, wherein one or more items of the communication information that are not to be visually output can be freely selected.

3. The communication apparatus as claimed in claim 2, wherein the items that are not to be visually output include an item that identifies a receiving party.

4. The communication apparatus as claimed in claim 3, wherein the item that identifies the receiving party is a telephone number.

5. The communication apparatus as claimed in claim 3, wherein the item that identifies the receiving party is an individual identifier such as a name of a person and a corporation, the individual identifier being beforehand registered corresponding to a telephone number.

6. The communication apparatus as claimed in claim 3, wherein the item that identifies the receiving party is a specific number that is transmitted with a telephone number, the specific number being pre-registered by a sending party and the receiving party.

7. The communication apparatus as claimed in claim 2, wherein the setting means substitutes the items of information that are not to be visually output by a substituting character string.

8. The communication apparatus as claimed in claim 7, wherein the substituting character string is one or more asterisks.

9. The communication apparatus as claimed in claim 1, wherein the output means causes the visual output means to output the communication information concerning the communication history when outputting a transmission result report or a non-delivery report as applicable for every communication.

10. The communication apparatus as claimed in claim 1, wherein the output means causes the visual output means to output the communication information concerning the communication history when outputting a communication management report.

11. The communication apparatus as claimed in claim 1, wherein the output means causes the visual output means to output the communication information concerning the communication history during a communication accompanying a transmission action.

12. The communication apparatus as claimed in claim 1, wherein the visual output means is a printer that carries out printing on recording paper.

13. The communication apparatus as claimed in claim 1, wherein the visual output means is a control-panel unit that includes a display screen.

14. The communication apparatus as claimed in claim 1, further comprising:
second output means for causing the visual output means to output a list of contents of the setup carried out by the setting means.

15. A communication apparatus capable of transmitting and receiving information, comprising:
a visual output unit that visually outputs various information items;
a setting unit that selectively sets up information that is not to be visually output, the information being contained in communication information concerning communication history; and
an output unit that outputs the communication information concerning the communication history to the visual output unit according to the setup carried out by the setting unit.

16. The communication apparatus as claimed in claim 15, wherein one or more items of the communication information that are not to be visually output can be freely selected.

17. The communication apparatus as claimed in claim 16, wherein the items that are not to be visually output include an item that identifies a receiving party.

18. The communication apparatus as claimed in claim 17, wherein the item that identifies the receiving party is a telephone number.

19. The communication apparatus as claimed in claim 17, wherein the item that identifies the receiving party is an individual identifier such as a name of a person and a corporation, the individual identifier being beforehand registered corresponding to a telephone number.

20. The communication apparatus as claimed in claim 17, wherein the item that identifies the receiving party is a specific number that is transmitted with a telephone number, the specific number being pre-registered by a sending party and the receiving party.

21. The communication apparatus as claimed in claim 16, wherein the setting unit substitutes the items of information that are not to be visually output by a substituting character string.

22. The communication apparatus as claimed in claim 21, wherein the substituting character string is one or more asterisks.

23. The communication apparatus as claimed in claim 15, wherein the output unit causes the visual output unit to output the communication information concerning the communication history when outputting a transmission result report or a non-delivery report as applicable for every communication.

24. The communication apparatus as claimed in claim 15, wherein the output unit causes the visual output unit to output the communication information concerning the communication history when outputting a communication management report.

25. The communication apparatus as claimed in claim 15, wherein the output unit causes the visual output unit to output the communication information concerning the communication history during a communication accompanying a transmission action.

26. The communication apparatus as claimed in claim 15, wherein the visual output unit is a printer that carries out printing on recording paper.

27. The communication apparatus as claimed in claim 15, wherein the visual output unit is a control-panel unit that includes a display screen.

28. The communication apparatus as claimed in claim 15, further comprising:
a second output unit that causes the visual output unit to output a list of contents of the setup carried out by the setting unit.

29. A communication information managing method, comprising:
a set up step of setting up one or more items of communication information concerning communication history, the items being set up such that the items are not to be visually output, and
an output step of visually outputting the communication information concerning the communication history according to the setup carried out by the setup step.

30. A communication management program that is installed in a computer of a communication apparatus that is capable of transmitting and receiving information, and that includes a visual output unit that visually outputs various information items, the communication management program being executed by the computer in order to perform
a setting up function that sets up one or more items of communication information concerning the communication history that are not to be visually output, and
an output function that causes the visual output unit to output the communication information concerning the communication history according to the setup carried out by the setting up function.

31. A storage medium that stores the communication management program as claimed in claim 30.
